(19) United States
(12) Patent Application Publication
(10) Pub. No.: US 2007/0064572 A1
(43) Pub. Date: Mar. 22, 2007

(54) Optical data encoding and detection

(75) Inventor: Oron Zachar, Tel Aviv (IL)

Correspondence Address: SIMON KAHN;c/o LANDONIP, INC, 1700 DIAGONAL ROAD, SUITE 450, ALEXANDRIA, VA, 22314-2866, US

(73) Assignee: Polarizonics Corporation, Los Angeles, CA (US)

(21) Appl. No.: 11/530,963

(22) Filed: Sep. 12, 2006

Related U.S. Application Data
(63) Continuation-in-part of application No. 11/189,857, filed on Jul. 27, 2005.
(60) Provisional application No. 60/715,594, filed on Sep. 12, 2005.
(60) Provisional application No. 60/731,471, filed on Oct. 31, 2005.
(60) Provisional application No. 60/751,969, filed on Dec. 21, 2005.

(51) Int. Cl. G11B 7/00; G11B 7/24

(52) U.S. Cl. 369/110.01; 369/275.4

(57) ABSTRACT

A method of recording information comprising combining three degrees of freedom of pit geometry and layout along the track, the three degrees of freedom comprising: using several pit lengths for run-length timing encoding: using several pit shapes to influence the collected light intensity level; and using several pit planar orientations to influence the reflected polarization orientation, thereby recording information in the timing, light intensity, and light polarization signals of the pits.

### CROSS-REFERENCE TO RELATED APPLICATIONS

This application claims priority from: U.S. Provisional Patent Application Ser. No. 60/715,594 filed Sep. 12, 2005 entitled “Method and System for Encoding and Detecting Optical Information”; U.S. Provisional Patent Application Ser. No. 60/731,471 filed Oct. 31, 2005 entitled “System for Encoding and Detecting Optical Information”; and U.S. Provisional Patent Application Ser. No. 60/751,969 filed Dec. 21, 2005 entitled “Optical Data Encoding and Detection”. This application is also a continuation-in-part of U.S. patent application Ser. No. 11/189,857 filed Jul. 27, 2005 entitled “Method and System for Encoding and Detecting Optical Information”.

### BACKGROUND OF THE INVENTION

The invention relates generally to the field of optical data storage and in particular to a means for increased data storage based on pit orientation.

The increasing need for data storage has been a consistent driver for expanding the data density of various media. Optical storage has recently become very common, with a standard optical compact disc (CD) having a typical capacity of over 750 megabits. Digital video disc (DVD) technology is also common, having a capacity of around 4.7 gigabits, and technologies enabling discs with capacity of 25-50 gigabits have recently been introduced.

In the above technologies a light source, such as a laser diode, is used to read a pattern of marks written on a substrate. Typically a low cost red light laser is preferred, although advanced technologies utilizing a blue laser for increased storage density have been introduced. Marks typically comprise pits or bulges written on a substrate, and are encoded in a binary pattern.

Typically, only two elements of the pit geometry are used to encode information. A first element is the transition from “land” to “pit” location of beam focus, where “land” refers to the top surface area of the disc reflecting layer and “pit” refers to bottom of a pit area. The transition from land to pit location of the beam is identified by a change in the intensity of light collected in the detectors; high intensity is reflected from land and lower intensity from pit locations.

A second element is the length of pits. Variable length of pits is also used to record information by a method commonly known as run-length encoding. Most current optical recording systems use a so-called bit modulation encoding to modulate the data to be stored so that it fits to the optical recording channel. The prevailing bit modulation encoding is run length limited encoding (RLL-encoding). Run length limited sequences are characterized by two parameters, d and k, which stipulate the minimum and maximum run length, respectively, that may occur in the sequence. The length of time, usually expressed in channel bits, between consecutive transitions between land and pit (i.e., between beginning of pit and end of pit) is known as the run length. Run length constraints help to mitigate problems of inter-symbol interference and inaccurate clocking. The d-constraint helps to reduce inter-symbol interference, and the k-constraint helps to avoid inaccurate clocking.

The use of a binary pattern simplifies the detection and proper translation of the mark, but it also limits the amount of data storage that can be supplied in a given data media. Furthermore, the use of a binary pattern negatively impacts the ultimate data reading rate. Data storage is ultimately limited by the size of the mark, and the ability to differentiate between adjacent marks. An increase in data density typically leads to an increase in the ultimate data reading rate. High Definition Television (HDTV) requires a data read rate on the order of 18 Mb/s, which is well above the current capabilities of red laser based DVD technology.

Increased density is available by utilizing a blue light laser source having a shorter wavelength than the commonly utilized red light laser source; however this results in increased costs. Furthermore, the use of a blue light laser source does not optimize storage on a given media, since the use of a binary coding method places a limitation on the amount of data that may be stored.

Encoding methods other than binary are known in the art and have been suggested in inter alia U.S. Pat. No. 5,144,615 entitled “APPARATUS AND METHOD FOR RECORDING AND REPRODUCING MULTILEVEL INFORMATION” issued to Kobayashi and U.S. Pat. No. 6,657,933 entitled “METHOD AND APPARATUS FOR READING AND WRITING A MULTILEVEL SIGNAL FROM AN OPTICAL DISC” issued to Wong et al, the contents of both of which are incorporated herein by reference. The multilevel here refers to modulation of the reflected light intensity. Unfortunately, in practice the use of multi-level encoding has been found to be somewhat difficult, and has not satisfactorily maximized the storage on the optical media.

U.S. Pat. No. 5,880,838 entitled “SYSTEM AND METHOD FOR OPTICALLY MEASURING A STRUCTURE” issued to Marx and Psaltis, the entire contents of which is incorporated herein by reference, is addressed to a system and method for measuring the dimensions of a small (e.g., microelectronic) structure. The invention is an optical system and method that uses a linearly polarized light beam, reflected off or transmitted through, a structure, to measure the structural parameters, such as the lateral dimensions, vertical dimensions, height, or the type of structural material. The system employs a light source to generate a light beam that is linearly polarized and focused onto the structure to be measured. The structure is illuminated with TE and TM polarized light. The structure is dimensioned such that the TM and TE fields are affected differently by the diffraction off the structure. As a result, either the TE or TM field can be used as a reference to analyze the phase and amplitude changes in the other field. Differences between the diffracted TE and TM far fields allow a comparison of the relationship between the amplitude and phase of those fields to determine the structural parameters of a structure.

U.S. Pat. No. 6,512,733 entitled “OPTICAL RECORDING METHOD, OPTICAL RECORDING APPARATUS, OPTICAL READING METHOD, AND OPTICAL READING APPARATUS” issued to Kawano et al is addressed to a recording method in which a plurality of polarization distributions corresponding to the data information is generated and irradiated onto an optical recording medium to thereby record a plurality of polarization distributions of the recording light on the optical recording medium as photo-induced birefringence. Unfortunately, only a limited selection of materials having the appropriate photo-induced birefringence which is retained is available.

U.S. Pat. No. 5,453,969 entitled “OPTICAL MEMORY WITH PIT DEPTH ENCODING” issued to Psaltis et al is addressed to an optical storage medium constituting a substrate imprinted with optically detectable pits, each of the pits having one of a set of predetermined pit depths. Varying the pit depth enables an improved encoding density. Unfortunately, this has not been commercially successful, at least partially due to the difficulty in obtaining good resolution. Furthermore, it would be desirable to have a method of encoding which enables a further increase in density.

Patent Abstracts of Japan Publication Nr. 04-038720 based on an unexamined application by Yutaka and Chiaki of Jun. 1, 1990 describes multi-state recording executed by inclining the recording pit or groove by a prescribed angle to the track direction. A resultant diffraction beam intensity pattern is formed on two line sensors by using an optical system. The diffraction pattern rotates by an angle corresponding to the inclination of the recording pit or groove. The amount of inclination is detected by the two line sensors, which act to detect the boundary point of light and darkness of the diffraction pattern. Detection is thus accomplished by a light intensity pattern of reflected/diffracted light. Unfortunately, resolution based on light intensity is difficult and has not been commercially successful.

Thus, there is a need for an improved encoding method having an improved resolution suitable for use with low cost optical storage media.

### SUMMARY OF THE INVENTION

Accordingly, it is a principal object of the present invention to overcome the disadvantages of prior art encoding methods. This is provided in the present invention by encoding data by planar orientation of marks, such as pits. The marks are sized to be of sub-wavelength width, with a length greater than the width. The depth or height of the mark is preferably λ/4, however other depth or heights may be used without exceeding the scope of the invention. A polarized light source is used to read the mark, either by reflection or transmission. Collected light exhibits an elliptic polarization anisotropy, with the principle axis of the ellipse corresponding to the planar orientation of the mark. The collected light is detected by at least one polarization sensitive detector. The output of the detector is used to determine the direction of the axis of the polarization ellipse thereby decoding the orientation of the mark being read.

The invention further provide a method for recording of information by combining three degrees of freedom of pit geometry and layout along the track: a) using several pit lengths for run-length timing encoding; b) using several pit shapes to influence the collected light intensity level; and c) using several pit planar orientations to influence the reflected polarization orientation. Thus, we record information in the timing, light intensity, and light polarization signals associated with each of the pits.

For a given incident beam of fixed polarization (e.g., circular polarization), a rotation of the mark orientation gives rise to a corresponding rotation of the reflected light polarization ellipse. Thus, the planar orientation of the mark which may be set to one of a plurality of conditions encodes data.

Additionally the polarization ellipticity corresponds with the dimensional aspect ratio of the mark. Thus, in one embodiment information is encoded in the dimensional aspect ratio of the mark orthogonally with the planar orientation.

Additionally, the total intensity of the reflected light corresponds with the mark surface area. Thus, in one embodiment information is encoded in the total mark surface area orthogonally with encoding with either or both planar orientation and the dimensional ratio.

The invention provides for an optical storage medium designed to be readable with light of a pre-determined wavelength, the optical storage medium comprising: a substrate; and a plurality of optically detectable marks imprinted on the substrate, each of the plurality of optically detectable marks exhibiting: a predetermined length; a width less than the pre-determined wavelength; and one of a plurality of orientations in relation to a common axis, wherein information is stored on the optical storage medium at least partially as a function of the one of a plurality of orientations.

Advantageously, the invention further provides for a method of tracking by considering only a subset of the pits on the track.

Further advantageously, the invention provides principles and methods for improving the signal to noise ratio. Additionally the invention provides principles of error correction coding.

Additional features and advantages of the invention will become apparent from the following drawings and description.

### BRIEF DESCRIPTION OF THE DRAWINGS

For a better understanding of the invention and to show how the same may be carried into effect, reference will now be made, purely by way of example, to the accompanying drawings in which like numerals designate corresponding elements or sections throughout.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 illustrates a view of a substrate comprising a plurality of marks exhibiting orientation based encoding according to the principle of the invention;

FIG. 2a illustrates a top view of a mark illustrating various possible orientations;

FIG. 2b illustrates an example of elliptical anisotropy created by reflection from the varying sub-wavelength pit orientation 20 of FIG. 2a;

FIG. 3 illustrates a 3 dimensional view of a pit embodiment of a mark according to the principle of the invention;

FIG. 4 illustrates a right-handed orthogonal coordinate system with an ellipse whose major axis is at an angle γ to a coordinate î;

FIG. 5 illustrates a high level diagram of an optical memory system according to an embodiment of the principle of the invention comprising a polarized light source, two polarization circularizing elements, an aperture, a polarization state determining module, and at least one tracking and focus module;

FIG. 6 illustrates a high level block diagram of an embodiment of the polarization state determiner module of FIG. 5;

FIG. 7 illustrates the blocking action of the aperture, and further illustrates the “viewing angle” φₜ;

FIG. 8 illustrates a high level diagram of an optical memory system according to an embodiment of the principle of the invention, exhibiting a modified location of the incident beam polarization circularizing element;

FIG. 9 illustrates a high level diagram of an optical memory system including high level stages of recording and playback in accordance with the principle of the current invention;

FIG. 10 illustrates orientations for selected pit lengths, and in particular, highlights that even long pits can have some degree of rotational freedom, even though they cannot be rotated through full range of 180 degrees because of limitation of the track width; and

FIG. 11 illustrates an exemplary section of three parallel tracks, where both run-length and pit rotation is employed.

### DETAILED DESCRIPTION OF THE PREFERRED EMBODIMENTS

The present embodiments enable encoding data in an optical memory by planar orientation of marks, such as pits or bumps. The marks are sized to be of sub-wavelength width, with a length comparable to, or larger than, the wavelength. The operative wavelength is hereinafter denoted by λ. The depth or height of the mark is preferably λ/4, however other depth or heights may be used without exceeding the scope of the invention. A polarized light source is used to read the mark, typically by one of reflection and transmission. Collected light exhibits an elliptic anisotropy, with the principle axis of the ellipse corresponding to the planar orientation of the mark. The collected light is detected by a plurality of polarization sensitive detectors, the intensity and polarization pattern of the collected light indicating the direction of the axis of the ellipse. Thus, the varying planar orientation of the mark encodes the data.

The specific relationship between the mark orientation and the elliptic polarization orientation of the reflected light may depend upon various parameters such as the mark depth and the material composition of the optical substrate, however in practice for a given optical memory unit, such a specific disc, may be taken as fixed.

Marks are typically embodied in pits which are formed in close proximity to one another. Consequently, a beam of light focusing on a specific pit also results in residual illumination of neighboring pits, the reflection from which results in interference with the reflection of the specific pit of interest. The ability to thus properly decode the orientation of the specific pit of interest from the measured light polarization is limited in resolution due to such interference reflection from neighboring pits. It is a further object of the current invention to reduce the range of such shifts of orientation thereby enhancing the angular resolution of detection and determination of the orientation of the specific pit of interest.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

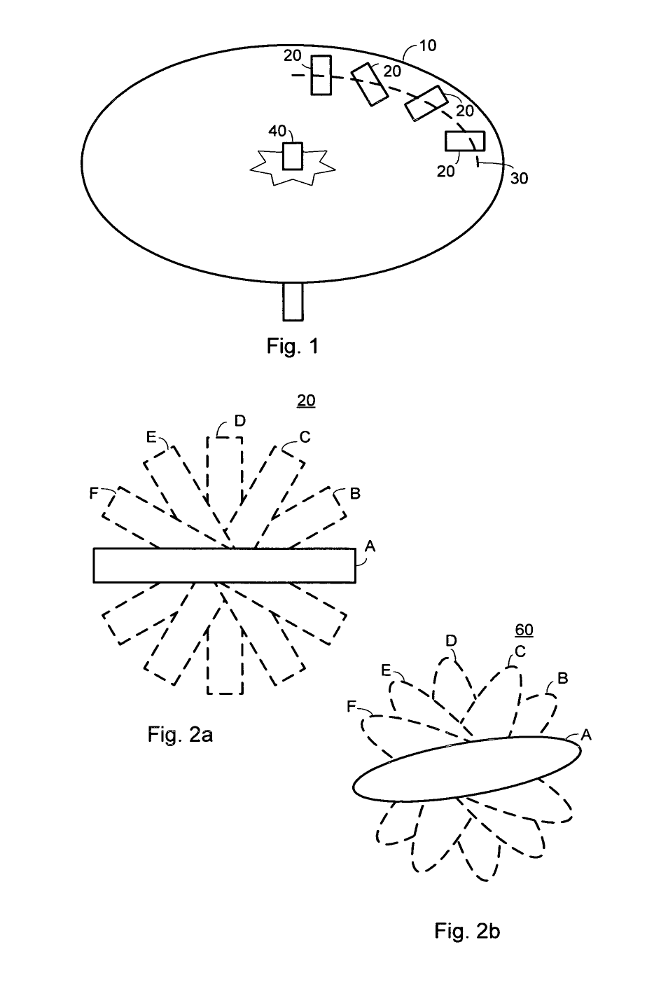

FIG. 1 illustrates a high level view of an optical recording medium according to the principle of the invention. The optical recording medium comprises substrate 10 having imprinted thereon a plurality of marks 20, each of the plurality of marks 20 having a sub-wavelength aperture and exhibiting orientation based encoding in relation to a spiral track 30, and a center spindle 40 according to the principle of the invention. Spiral track 30 defines a reference point in relation to center spindle 40 for placement and orientation of marks 20. Placement of marks 20 along a path defined by spiral track 30 allows for ease of reading, since the location of marks 20 is well defined. Various orientations of marks 20 are shown, with data being encoded at least partially by the orientation of marks 20 in relation to spiral track 30.

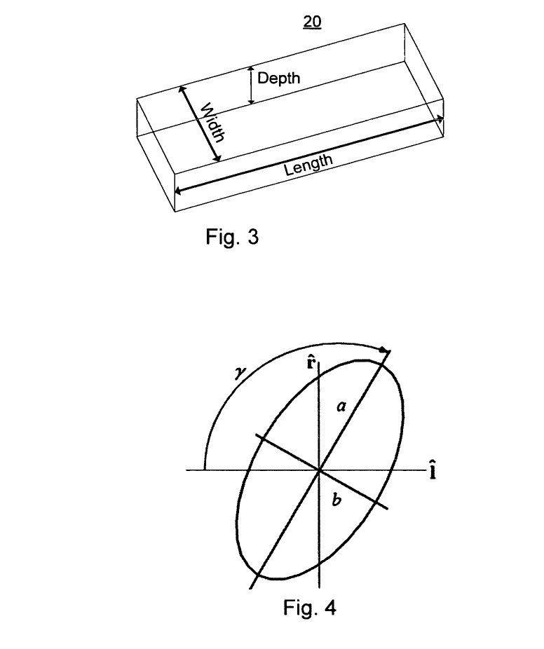

FIG. 2a illustrates a top view of a mark 20 illustrating six possible orientations, labeled A-F, respectively. Six orientations are shown for clarity, however this is not meant to be limiting in any way. Eight or more orientations are specifically included, with the limiting factor being the ability to optically discern the orientation. The invention provides for optically discerning the orientation utilizing polarized light in a manner that will be explained further hereinto below. As described further below, mark 20 comprises a sub-wavelength aperture.

Polarized light transmitted through, or reflected from, a sub-wavelength pit or aperture, in which the width is less than the wavelength of the light and the length is longer than the width exhibits an elliptical shape. The effect is such that light polarized along the axis parallel to the length of the sub-wavelength aperture sees an aperture of a size less than a wavelength. Light polarized along the axis parallel to the width of the sub-wavelength aperture sees a larger aperture and penetrates to a greater extent than the light polarized parallel to the length of the aperture. It is to be understood that mark 20 may be embodied in either a pit or a bump, and the term pit is used interchangeably herein with the term aperture. The invention is being described in an embodiment in which the mark is a pit, however this is not meant to be limiting in any way, and the invention may be practiced in an embodiment comprising optically detectable marks without exceeding the scope of the invention.

Polarized light transmitted through, or reflected from, a sub-wavelength aperture having a width of less than the wavelength and a length larger than the width collected at an objective will have a certain elliptic anisotropy. The orientation of the principle axis of the ellipse is a function of the orientation of the axis of the aperture.

For clarity, the invention will now be further described in the case where mark 20 comprises a sub-wavelength aperture formed by a pit in a substrate, with light entering the pit impacting on a reflective layer. This is not meant to be limiting in any way, and the invention is equally applicable to raised marks of sub-wavelength aperture, or where the light is collected only after passing through the sub-wavelength aperture.

With a sub-wavelength mark 20 of some fixed physical dimensions, different planar orientations of the sub-wavelength mark 20 will manifest themselves in different orientations of the principle axis of elliptical anisotropy of the reflected light. A circularly polarized light is reflected with some elliptic polarization anisotropy where the principle axis of the ellipse is in correspondence with the orientation of elongated sub-wavelength mark 20. Thus, a one to one relationship between the orientation of the principle axis of the reflected light and the orientation of the principle axis of sub-wavelength mark 20 enables detection and ultimate decoding of orientation of sub-wavelength mark 20. The invention is herein described in relation to a circularly polarized incident beam, however this is not meant to be limiting in any way.

FIG. 2b illustrates an example of elliptical anisotropy created by reflection from the varying sub-wavelength pit orientation 20 of FIG. 2a as ellipses 60.

The possible orientations of polarization ellipses 60 are labeled A-F corresponding to the orientation of sub-wavelength pits 20 of FIG. 2a. It is to be noted that orientations A-F of ellipses 60 correspond to orientations A-F of sub-wavelength mark 20, however they are not necessarily aligned.

The specific relationship between the orientation of the polarization ellipse and the orientation of the pit axis is dependent upon the depth of the pit and the material composition and layer thicknesses of the disc structure. For a given disc structure and a given pit depth, rotation of the orientation of a pit by a specific angle will result in a similar angle of rotation of the reflected light polarization ellipse.

In a typical application, such as an embodiment of an optical memory on a disc, pits on the surface are formed in close proximity to one another. Consequently, a beam of light focusing on a specific pit also results in residual illumination of neighboring pits, the reflection from which results in interference with the reflection of the specific pit of interest. Residual illumination from neighboring pits results in interference resulting in an effective shift in the angle of rotation of the detected polarization ellipse. Thus the ability to decode the orientation of the pit of interest from the measured light polarization is limited in resolution due to interference reflection from neighboring pits. It is to be noted that interference may affect the collected light intensity and the eccentricity of the detected ellipse in addition to the above mentioned rotational effect.

FIG. 3 illustrates a 3 dimensional view of a sub-wavelength pit embodiment of mark 20 according to the principle of the invention. Sub-wavelength mark 20 exhibits a width less than the operative optical wavelength, λ, and a length greater than the width. In a preferred embodiment the width of sub-wavelength mark 20 is less than 80% of λ. In one further preferred embodiment the width of sub-wavelength mark 20 is less than or equal to 50% of λ. In another further preferred embodiment the width of sub-wavelength mark 20 is less than or equal to 40% of λ. In yet another further preferred embodiment the width of sub-wavelength mark 20 is less than or equal to 33% of λ.

Detection of the principle axis of polarization ellipse 60 of FIG. 2b is described in pending U.S. patent application Ser. No. 11/189,857 filed Jul. 27, 2005 entitled “Method and System for Encoding and Detecting Optical Information” the entire contents of which is incorporated herein by reference. Fundamentally, different reflection coefficients parallel and perpendicular to the pit give rise to a polarization rotation of the reflected light, and change an incident circular polarization to a reflected elliptic polarization. Prior art devices, such as DVD players, work with a circular polarized light source, and the present invention shows significant advantages over prior art systems when used with such a circular polarized light source

A complete description and detection of elliptic polarization can be accomplished using Stokes parameters. A detailed analysis and background can be found in F. Couchot et al., “Optimized Plarimeter Configurations for Measuring the Stokes Parameters of the Cosmic Microwave Background Radiation”, Astron. Astrophys. Suppl. Ser. Vol 135 p. 579 (1999) published by the European Southern Observatory, whose entire contents are incorporated herein by reference.

A complete description and detection of elliptic polarization is desired. Let \hat{r} and î form a right-handed orthogonal coordinate system with the propagation direction s as shown in FIG. 4. The semi-major axes of the ellipse are denoted “a” and “b”, and γ is the angle between î and major axis “a” of the ellipse. γ is the parameter of interest which defines “the orientation of the polarization ellipse”. The ellipse, which is in all respects similar to ellipse 60 of FIG. 2b is defined by three free parameters called Stokes parameters.
S₀=I=Iᵣ+I₁ is the total intensity. Equation (1)
S₁=Q=Iᵣ−I₁ indicates the degree of polarization Equation (2)
S₂=U=Q tan(2γ) Equation (3)
where we use the notation Iₓ to denote the measured light intensity with polarization x. It is also common to define the elliptic eccentricity as a/b.

The three stokes parameters can be determined from a measurement of at least 3 polarization measurements. An over specification by a larger number of detectors may be used to reduce the measurement error. The intensity detected by a polarimeter rotated by an angle γ as shown in FIG. 4 is given by:
I_{γ}=½*(I+Q cos 2γ+U sin 2γ) Equation (4)
Since there are three parameters, preferably a minimum of 3 detectors at different angles is utilized. Error is minimized when the detectors angles are evenly distributed over 180 degrees.

We shall explicitly present an analysis of an exemplary embodiment comprising 4 detectors. These should be understood by way of example, and do not exclude the application of a larger number of detectors or of detectors whose angular polarization orientation is not evenly distributed.

In the case of 4 detectors at polarization angles 0, 45, 90, 135 degrees, the Stokes parameters are found from the detector intensity measurements according to the following formulas:
S₀=I=I₀+I₉₀,
S₁=Q=I₀−I₉₀,
S₂=U=I₄₅−I₁₃₅. Equations (5)
It is common to define a fourth Stokes parameter which measures the difference between right-circular and left-circular light. The value of this parameter can also be determined by the optical system which is employed, however there is no requirement to obtain this fourth parameter.

The total intensity “I” is determined by the light source intensity and the shape and size of mark 20. Given the detected value U, then properly inverting equation 3 gives the value of the angle γ which determines the associated pit orientation. Furthermore, the eccentricity can be determined by

$$\frac{b}{a} = \sqrt{\frac{I - \sqrt{{Q}^{2} + {U}^{2}}}{I + \sqrt{{Q}^{2} + {U}^{2}}}} \qquad Equation ( 6 )$$

Therefore, the reflected light caries detectable information in the light intensity, the elliptic polarization orientation and the polarization ellipticity. These can be affected by the pit geometry in the following way: The reflected polarization orientation is in correspondence with the pit orientation. The reflected polarization eccentricity is correspondence with the pit dimensional aspect ratio. The pit surface area is in correspondence with the total reflected light intensity. Hence, combinations of these pit parameters can serve to encode information.

The polarization characteristics of the light reflected from a pit mark is not uniform in space. A detector effectively performs some average over its viewing window. Similarly, the set of detectors used for determining the Stokes parameters detects information which is used to obtain an average value of the Stokes parameters over the specific viewing window of the detectors. Thus, the obtained Stokes parameters vary depending on the position and viewing window of reflected light collected by the set of detectors. Preferably a mask or aperture, as will be described further hereinto below, limiting the angle of detection is utilized to improve discrimination of the Stokes parameters. It is further to be understood that there is no requirement to identify the Stokes parameters. In one embodiment an artificial neural network computation system in combination with the output of the various detectors identifies the pit orientation.

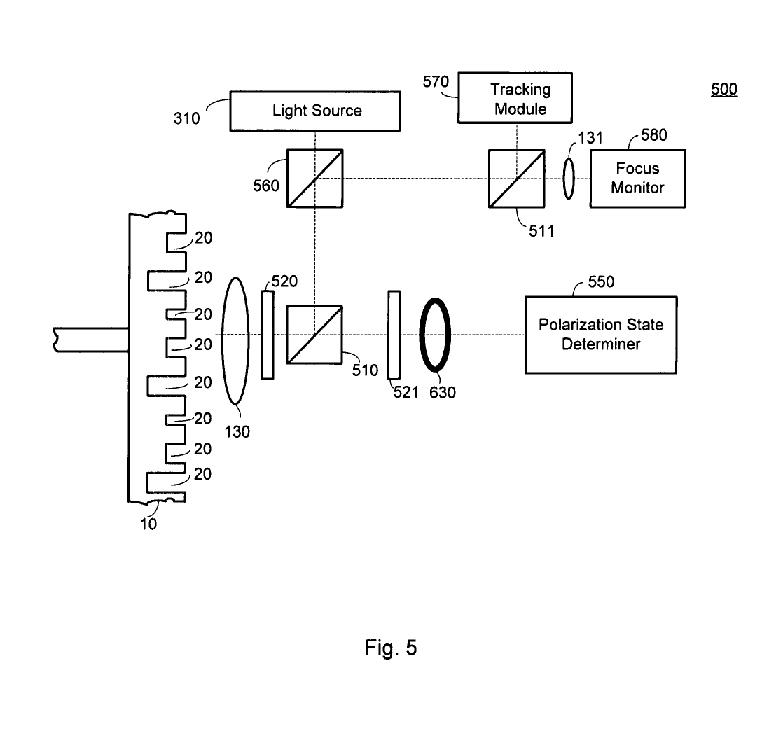

FIG. 5 illustrates a high level diagram of an optical memory system 500 according to an embodiment of the principle of the invention, comprising: a light source of linearly polarized light 310; a plurality of polarization circularizing prisms 520 and 521; a plurality of non-polarizing beam splitters (NPBS) 510, 511; an optional polarization beam splitter (PBS) 560; an angular window mask 630; a polarization state determiner (PSD) module 550; a tracking module 570; a focus monitor 580; a plurality of lenses 130; and a substrate 10 comprising a plurality of marks 20 on a spindle 40. In an exemplary embodiment light source 310 comprises a laser diode.

In operation, linearly polarized light exiting light source 310 is split by optional PBS 560, and a portion of the light is transmitted to NPBS 510. Preferably, the polarization axis of PBS 560 is aligned with that of the light source 310, such that most of the light source intensity is transmitted through A portion of the light received at NPBS 510 is directed towards the marks 20 via polarization circularizing prism 520 and lens 130. The polarization circularizing prism 520 is preferably a ¼ wave plate, converting the linear polarized light to circular polarized light incident on marks 20. Other realizations of the same circularizing function, employing various prism arrangements are known to those skilled in the art, and may be utilized without exceeding the scope of the invention. For clarity, the invention is herein described in relation to polarization circularizing prisms 520, 521 being constituted of ¼ wave plates however this is not meant to be limiting in any way.

Light reflected back from the mark 20 passes back through the ¼ wave plate of polarization circularizing prism 520 to NPBS 510. NPBS 510 reflects about 50% of the light back towards light source 310 and optional PBS 560 serves to prevent most of the reflection from arriving at light source 310, and instead directs it towards focus monitor 580 and tracking module 570 via NPBS 511. Tracking module 570 is operative, responsive to the received portion of the reflected light to determine any mistracking, and output a corrective signal to the optics controller (not shown). Focus monitor 580 is operative, responsive to the received portion of the reflected light to determine any misfocus, and output a corrective signal to the optics controller (not shown).

The remaining reflected light (about 50%) received at NPBS 510 is transmitted and passed through the ¼ wave plate of polarization circularizing prism 521. Polarization circularizing prism 521 is selected to be counter-circular to polarization circularizing prism 520. For ¼ wave plates, this is obtained by polarization circularizing prism 521 having its fast axis rotated 90 degrees to that of polarization circularizing prism 520. The objective of this operation is in effect to undo the action of the second pass of the reflected light through polarization circularizing prism 520, thus recovering the state of polarization as it was reflected from the surface of substrate 10. Light passing through polarization circularizing prism 521 is then partially transmitted through the optional angular window mask 630 to PSD module 550.

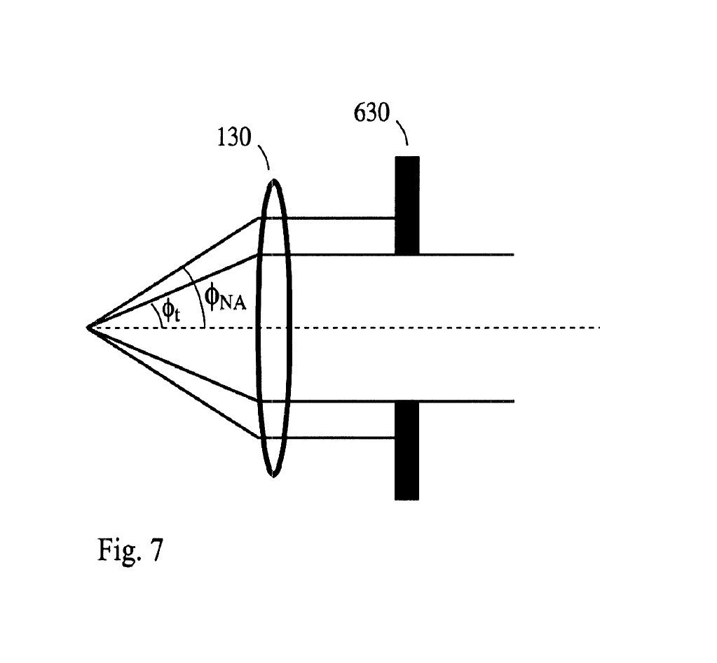

To minimize the variation of polarization states within the detector's window, it is preferable that optional angular window mask 630 be implemented as a circular mask 630 to limit the angular window φₜ of collected light to a specific range of angles. The meaning of this “viewing angular window” φₜ is depicted in FIG. 7., in which for clarity, only the lens 130 and angular window mask 630 parts of the optical system are explicitly drawn. Preferably, the choice of angular window is such that slight misalignments will not be a source of significant variation in the measured Stokes parameters. Also, a compromise needs to be made due to the fact that the bigger the angular window, the bigger is the total intensity of collected light. For a given incident beam diameter through a lens of given numerical aperture (NA), the maximum angle of focused light is window φ_{NA}.

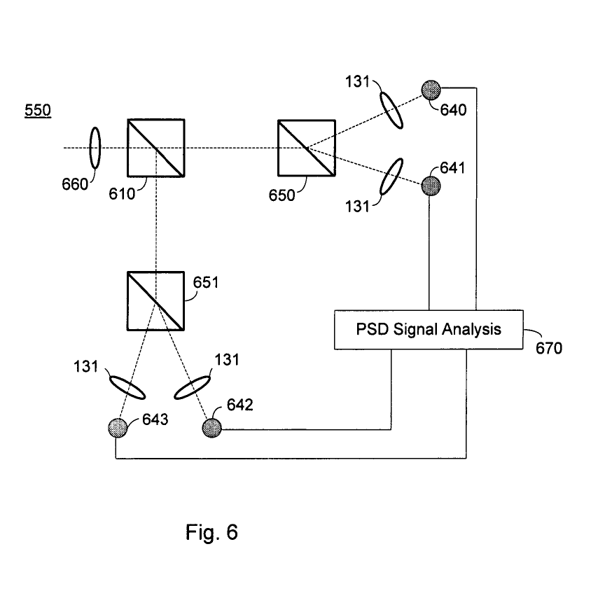

FIG. 6 illustrates a high level block diagram of an embodiment of PSD module 550 of FIG. 5 comprising: a focusing lens 660; an NPBS 610; a plurality of PBSs 650, 651; and a plurality of detectors 640, 641, 642, 643 each having an optional focusing lens 635 in front of it; and a signal analysis module 670. Signal analysis module 670 comprises electronics and computation instruments for computing the Stokes parameters from the output signals of the detectors, and optionally also the computation of the elliptical polarization properties of orientation, ellipticity, and total intensity.

In operation, light which was transmitted through angular window mask 630 of FIG. 5 is passed to NPBS 610, preferably through focusing lens 660. PBS 650 and 651, which each preferably receive approximately 50% of the light exiting NPBS 610 are preferably rotated 45 degrees relative to one another, so that the polarization of light arriving at detectors 640, 641, 642, 643, is at orientations 0, 90, 45, 135 degrees respectively. In an exemplary embodiment PBS 650 and 651, are constituted each of Wollaston type prisms, but alternative embodiments are known in the art of polarimeter instrument design. Alternatively, and utilizing a pair of Wollaston prisms, a ½ wave plate is provided (not shown) oriented with its axis at 22.5 degrees to the axis of PBS 650, and placed before light enters PBS 651. PBS 651 is then oriented with its active axis parallel to the axis of PBS 650.

The output of detectors 640-643 is received at PSD signal analysis module 670 which is operable, responsive to the output of detectors 640-643 to detect characteristics of the polarization ellipse thereby enabling calculation of the Stokes parameters. We note that since, for the purpose of the present invention, only three (S₀, S₁, S₂,) out of the general four Stokes parameters are needed, then in principle only a minimum of three detectors (each measuring a different polarization component) are needed in the PSD module 550.

PSD signal analysis module 670 preferably utilizes Equations 1-6, to calculate the orientation encoding of pits 20 as a function of the output of first, second, third and fourth detectors 640, 641, 642, 643. PSD signal analysis module 670 may be embodied in a software program in a general purpose computing platform, in a microcontroller, an ASIC or a neural network without exceeding the scope of the invention. Furthermore, the use of a plurality of detectors enables the decoding of each of the orientation of polarization ellipse 60, the total light intensity and polarization ellipticity. Thus pit aspect ratio, surface area and orientation encoding may be combined in a single mark 20.

Detectors 640, 641, 642, 643, may each have optional focusing lens 653 associated with it to focus the light on each detector. Preferably, if the optical distance between each detector and lens 680 are arranged to be equal, optional lens 660 may suffice to simultaneously focus the beam on all four detectors, and thus focusing lenses 130 are not required.

Alternative preferred embodiments of PSD module 550 are known from the art of polarimeter instruments design. Examples of such embodiments, including optical design and calibration methods, are discussed in Krishnan (1992), J. Opt. Soc. Am. A Vol. 9, No. 9, “Calibration, properties, and applications of the division-of-amplitude photopolarimeter at 632.8 and 1523 nm”; Azzam (1992), APPLIED OPTICS Vol. 31 No. 19, “Division-of-amplitude photopolarimeter based on conical diffraction from a metallic grating”; and U.S. Pat. No. 6,177,995 entitled “POLARIMETER and CORRESPONDING MEASURING METHOD” issued to Compain et al.; the entire contents of each of which are incorporated herein by reference. These various embodiments should not be taken as limiting but only as representative examples. In particular, since only three (S₀, S₁, S₂,) out of the general four Stokes parameters are needed for the purpose of the present invention, then in principle only a minimum of three detectors (each measuring a different polarization component) are needed in the PSD module.

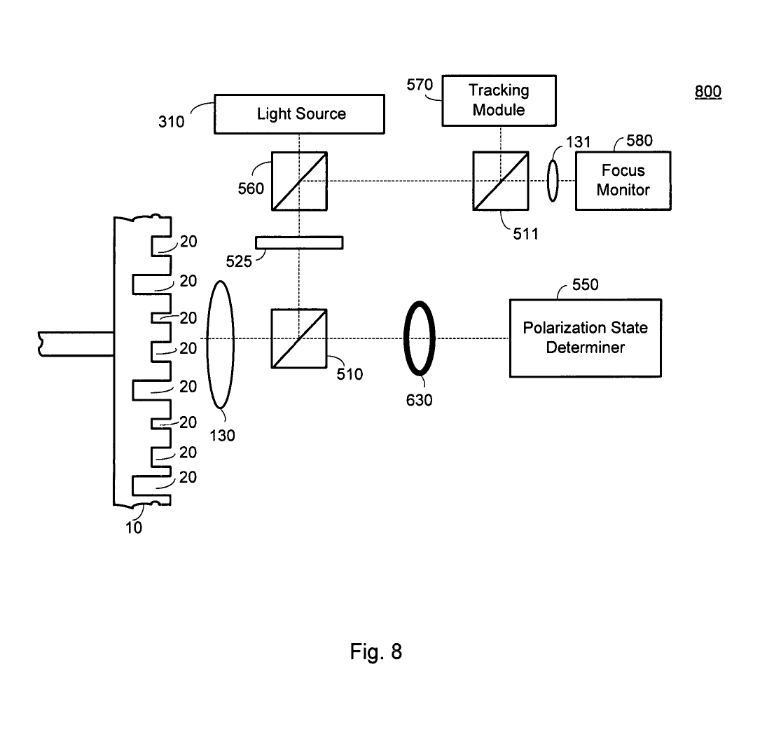

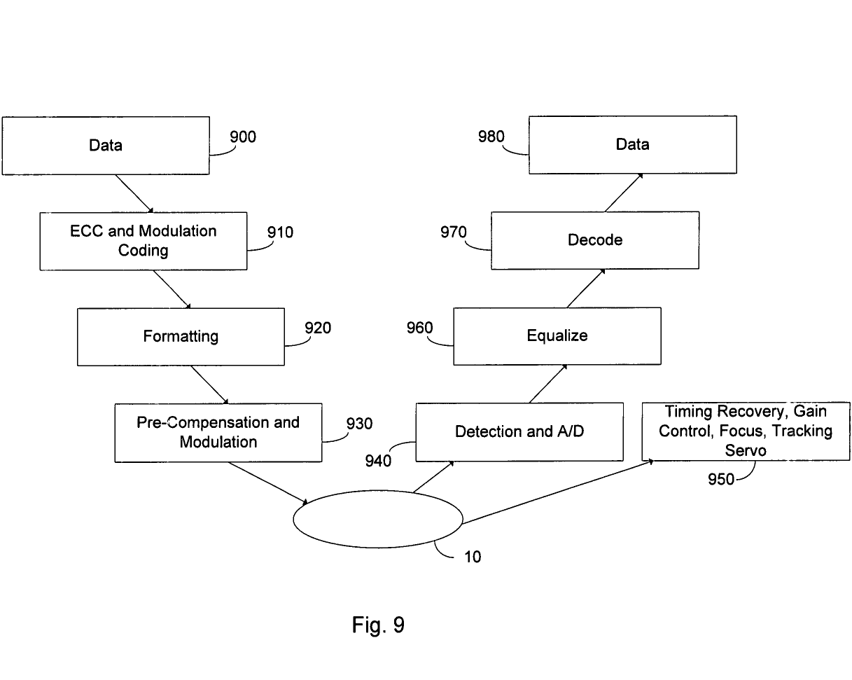

FIG. 8 illustrates a high level diagram of an optical memory system 800 according to an embodiment of the principle of the invention, exhibiting a modified location of the incident beam polarization circularizing element. In optical memory system 800, a polarization circularizing prism 525 is placed between PBS 560 and NPBS 510, thus the incident beam is circularly polarized when arriving at substrate 10. Since NPBS 510 may have slightly anisotropic reflection coefficients, polarization circularizing prism 525 is preferably adjusted to compensate for such anisotropy. For example, in a preferred embodiment, polarization circularizing prism 525 is a properly adjusted anamorphic-prism-pair. Advantageously, only a single polarization circularizing prism is required.

The operation of PSD module 550 determines the average Stokes parameters values (S₀, S₁, S₂,) for the light transmitted through the angular window mask 630. As described above in relation to FIG. 5, 6 various schemes for Stokes parameter determination are known to those skilled in the art, such as U.S. Pat. No. 6,836,327 to Yao entitled “In-Line Optical Polarimeter Based on Integration of Free-Space Optical Elements” and U.S. Pat. No. 6,177,995 to Compain et al entitled “Polarimeter and Corresponding Measuring Method” the entire contents of both of which are incorporated herein by reference.

In operation, linearly polarized light exiting light source 310 is split by optional PBS 560, whose polarization axis is aligned with that of the light source 310, such that most of the light source intensity is transmitted through, and thus most of the light is transmitted through polarization circularizing prism 525 to NPBS 510. Polarization circularizing prism 525 acts to circularly polarize the light. A portion of the light received at NPBS 510 is directed towards the marks 20 via lens 130.

Light reflected back from the marks 20 passes back through NPBS 510. NPBS 510 reflects about 50% of the light back towards light source 310 and optional PBS 560 serves to prevent most of the reflection from arriving at light source 310, and instead directs it towards focus monitor 580 and tracking module 570 via NPBS 511. Tracking module 570 is operative, responsive to the received portion of the reflected light to determine any mistracking, and output a corrective signal to the optics controller (not shown). Focus monitor 580 is operative, responsive to the received portion of the reflected light to determine any misfocus, and output a corrective signal to the optics controller (not shown). The remaining reflected light (about 50%) received at NPBS 510 is transmitted through the optional angular window mask 630 to PSD module 550.

To minimize the variation of polarization states within the detector's window, it is preferable that optional angular window mask 630 be implemented as a circular mask to limit the angular window φₜ of collected light to a specific range of angles as described above in relation to FIG. 7. The reflection, having encoded thereon the orientation of each of marks 20, and optionally the mark depths, and further optionally the mark aspect ratio, is received a PSD module 550 which in an exemplary embodiment is as described above in relation to FIG. 6. As described above, in an exemplary embodiment first, second, third and fourth detectors 640, 641, 642, 643 of FIG. 6 measure the polarization intensity at respective 0°, 45°, 90° and 135° with respect to the axis of detection. PSD signal analysis module 670 of FIG. 6 preferably utilizes Equations 1-6, to calculate the orientation encoding of pits 20 as a function of the output of first, second, third and fourth detectors 640, 641, 642, 643. PSD signal analysis module 670 may be embodied in a software program in a general purpose computing platform, in a microcontroller, an ASIC or a neural network without exceeding the scope of the invention.

Furthermore, the use of a plurality of detectors enables the decoding of each of the orientation of polarization ellipse 60, the total light intensity and polarization ellipticity. Thus mark aspect ratio, surface area and orientation encoding may be combined in a single mark 20.

Optical memory system 500 of FIG. 5, and optical memory system 800 of FIG. 8 have each been described as utilizing reflected light incident directly onto substrate 10 however this is not meant to be limiting in any way. Optical memory systems 500, 800 may be designed to use transmitted light or to use reflected light at an angle without exceeding the scope of the invention.

In one embodiment the use of a combination element as described above may further require the use of a light spreading elements such as an offset prisms and beam expanders.

Using a Set of Pits to Modulate Both Light Intensity and Polarization Angle in Combination with Run-Length Timing

Pits of different length are commonly used to encode data. In principle, we add a rotation degree of freedom to the encoding of data with any length of pit. Yet, due to the limited width of the track, pits longer than the track width cannot be rotated through the full range of 180 degrees.

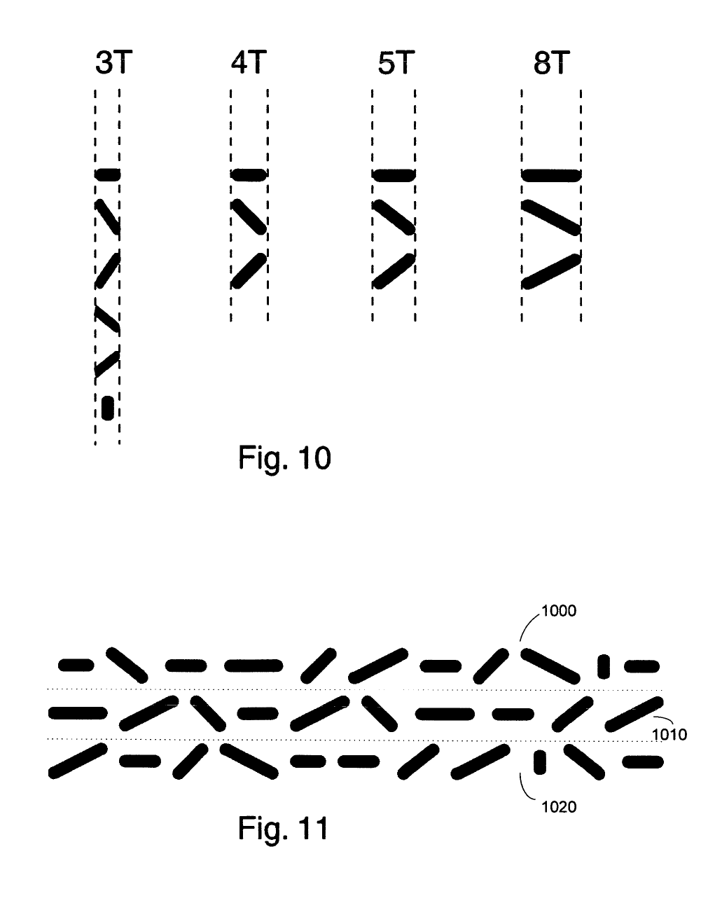

FIG. 10 illustrates orientations for selected pit lengths, and in particular, highlights that even long pits can have some degree of rotational freedom, even though they cannot be rotated through full range of 180 degrees because of limitation of the track width.

Since the run-length method of encoding information is based on the timing of signals, a fixed given run length is associated with the projection of the pit length along the track direction. Therefore, as illustrated in FIG. 10, each pit of a given run length that is rotated away from the track direction needs to be elongated such that its projection along the track is the same as the pit associated with the same run length that is parallel to the track.

In a preferred embodiment, one makes an exception for the shortest run length pit, as illustrated in pits 3T in FIG. 10. Thus the shortest run length pit can be rotated through the full range of 180 degrees.

For each of the pits, it is known in the art that cross section variations such as pit depth and pit width affect the intensity of collected light reflected from the pit. Therefore, in a preferred embodiment, a set of pit run lengths is selected, and for each such run length there will a multi-state of pits consisting of pits of several planar orientations (as depicted in FIG. 10) and pit cross sections. The pit orientation is detected by the reflected light polarization orientation and the pit shape is detected by the relative light intensity.

An advantage of having such a collection of run-length pit states is that several bits of information can be encoded in the same spatial area where previously there was only one. For example, if each run-length pit would have 3 possible orientations and 3 possible cross sections then there are 9 pit states which enable the encoding of 1n(9) bits of information. Thereby, the density of recorded information per unit area is increased.

In an alternative preferred embodiment, the shortest pit can have a set of orientation spanning full 180 degrees.

Since the identification of one pit implies the reading of multiple bit of information, the information read rate is also increased compared with a conventional disc of binary pits rotating at the same speed.

It is known in the art that one needs to compromise between the disc rotational speed and the bit length in a run-length encoding method. The recorded information density can be further increased by making the bit length shorter in the run-length method. Therefore, in an alternative embodiment of the present invention, the information density is further increased by making the bit length shorter compared with the limit of binary coding with the same information reading rate.

FIG. 11 illustrates an exemplary section of three parallel tracks, labeled track 1000, track 1010 and track 1020 respectively, wherein both run-length and pit rotation is employed.

Method of Tracking by Considering Only a Subset of the Pits on the Track

Methods of tracking error detection and correction are known in the art for the case when the pits long axis is parallel along the track, as in DVD-ROM. A subset of the pits according to the present invention exhibit a long axis parallel to the track. Therefore, the tracking methods known in the art can also be applied to the present invention with the addition of a condition that tracking signals arc taken into consideration only from the subset of track-parallel pits.

In a preferred embodiment, the tracking signal and elliptic polarization angle signals are collected. Then, the pit orientation is inferred from the polarization angle. The tracking signal is analyzed and acted upon only for signals coming from pits identified to be oriented parallel to the track.

Method of Identification of Location of Pit Center

Polarization ellipse eccentricity is minimum at pit center. Also reflected intensity is minimum at pit center. Therefore, algorithms known to the art for detecting pit centers by intensity, are applied so as to properly ascertain the pit center in order to calculate the eccentricity. In particular, preferably we first obtain two independent measures {p1,p2} of pit center position. Then, a convolution f(p1,p2) of the two measures can be constructed to obtain the choice strategy for delineating the pit center. For example, using multiplication f(p1,p2)=p1*p2.

In addition, an optional control parameter of detection of pit location using time/distance from previous pit is utilized, since pits are equally spaced (equal distance from center of one pit to the next).

Calibration of Orientation Determiner

Ideally, NPBSs 510, 511 of FIGS. 5, 8 and NPBS FIG. 6, split the beam intensity 50% evenly in each direction without affecting the polarization properties. In reality, manufactured NPBSs deviate from this ideal. Similarly, PBS 560 of FIGS. 5, 8 and PBSs 650, 651 of FIG. 6 ideally split orthogonal components of incoming light, but in reality the effect on one polarization component may differ from the other (e.g., in terms of the effective transmission coefficients). The process of system calibration amounts to introducing compensation in the signal processing system, so as to compensate for the anisotropies of the optical system. A general method of calibration is discussed in Krishnan (1992), J. Opt. Soc. Am. A Vol. 9, No. 9, “Calibration, properties, and applications of the division-of-amplitude photopolarimeter at 632.8 and 1523 nm” the entire contents which are incorporated herein by reference.

The general principle is the following: the measurements vector D=(D₁, D₂, . . . , D_{N}) of the set of N detectors (each measuring a different component of reflected beam polarization) is used to compute the three Stokes parameters vector S=(S₀, S₁, S₂,), by means of instrument Muller matrix M, with the vector equation S=M*D. The required instrument matrix M is obtained by the calibration method as described by Krishnan (1992).

Coding and Signal Processing

As described above, preferably information is encoded in both the intensity and polarization of light. This is accomplished by encoding information in the size and depth of an elliptic shape mark, preferably a pit, as well as the pit's relative orientation with respect to the in-track direction. The intensity and polarization control can be applied to pits of different length, so that information can also be encoded in the pit length as, for example, is done in the run-length method.

Thus, the present embodiments enable encoding data by planar orientation of marks, such as pits. The marks are sized to be of sub-wavelength width, with a length greater than the width. The depth or height of the mark is preferably λ/4, however other depth or heights may be used without exceeding the scope of the invention. A polarized light source is used to read the mark, either by reflection or transmission. Collected light exhibits an elliptic polarization anisotropy, with the principle axis of the ellipse corresponding to the planar orientation of the mark. The collected light is detected by at least one polarization sensitive detector. The output of the detector is used to determine the direction of the axis of the polarization ellipse thereby decoding the orientation of the mark being read.

For a given incident beam of fixed polarization (e.g., circular polarization), a rotation of the mark orientation gives rise to a corresponding rotation of the reflected light polarization ellipse. Thus, the planar orientation of the mark which may be set to one of a plurality of conditions encodes data.

Additionally the polarization ellipticity corresponds with the dimensional aspect ratio of the mark. Thus, in one embodiment information is encoded in the dimensional aspect ratio of the mark orthogonally with the planar orientation.

Additionally, the total intensity of the reflected light corresponds with the mark surface area. Thus, in one embodiment information is encoded in the total mark surface area orthogonally with encoding with either or both planar orientation and the dimensional ratio.

The invention provides for an optical storage medium designed to be readable with light of a pre-determined wavelength, the optical storage medium comprising: a substrate; and a plurality of optically detectable marks imprinted on the substrate, each of the plurality of optically detectable marks exhibiting: a predetermined length; a width less than the pre-determined wavelength; and one of a plurality of orientations in relation to a common axis, wherein information is stored on the optical storage medium at least partially as a function of the one of a plurality of orientations.

Advantageously, the invention further provides for an improved method of pit center location identification. Further advantageously, the invention provides principles and methods for improving the signal to noise ratio. Additionally the invention provides principles of error correction coding.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

It will be appreciated by persons skilled in the art that the present invention is not limited to what has been particularly shown and described hereinabove. Rather the scope of the present invention is defined by the appended claims and includes both combinations and sub-combinations of the various features described hereinabove as well as variations and modifications thereof, which would occur to persons skilled in the art upon reading the foregoing description.

I claim:

1. A method of recording information comprising combining three degrees of freedom of pit geometry and layout along the track, said three degrees of freedom comprising:
using several pit lengths for run-length timing encoding;
using several pit shapes to influence the collected light intensity level; and
using several pit planar orientations to influence the reflected polarization orientation,
thereby recording information in the timing, light intensity, and light polarization signals of the pits.

2. An optical information reading apparatus comprising:
an optical storage medium comprising a plurality of optically detectable marks, each of said marks having an orientation selected from a plurality of pre-determined orientations, said marks exhibiting one of a plurality of pre-determined lengths and a width less than a pre-determined wavelength;
a linearly polarized light source outputting light of said pre-determined wavelength;
a means for circularly polarizing said output light in optical communication with said linearly polarized light source;
a means for focusing the circularly polarized output light on one of said plurality of optically detectable marks;
a polarization state determiner in optical communication with said plurality of optically detectable marks, said polarization state determiner being operable to detect an orientation of a polarization ellipse as a consequence of said focused light of said pre-determined wavelength having interacted with said mark of said optical storage medium; and
a tracking mechanism operable responsive to optically detectable marks having a single orientation of said plurality of pre-determined orientations.

3. An optical information reading apparatus according to claim 2, further comprising an angular window mask arranged to limit the angular window of light received by said polarization state determiner from said plurality of optically detectable marks.

4. A method of recording optical information comprising:
receiving a plurality of data bits;
encoding said received data bits on an optical medium as one of a plurality of pit lengths;
encoding said received data bits as one of a plurality of pit shapes; and
encoding said received data bits as one of a plurality of planar orientations in relation to a common track axis, said one of a plurality of planar orientations influencing a reflected polarization orientation.

5. A method according to claim 4, wherein said optical medium exhibits a characteristic wavelength of light for use therewith.

6. A method according to claim 5, wherein said plurality of pit shapes each exhibit a width less than said characteristic wavelength of light.

7. A method according to claim 5, wherein said plurality of pit shapes each exhibit a width less than or equal to ½ said characteristic wavelength of light.
